(19) United States
(12) Patent Application Publication
(10) Pub. No.: US 2011/0005111 A1
(43) Pub. Date: Jan. 13, 2011

(54) CHANGEABLE SIGNAGE SYSTEM AND METHOD

(76) Inventor: Stuart ERSKINE, Camrose (CA)

Correspondence Address: HARNESS, DICKEY & PIERCE, P.L.C., P.O. BOX 828, BLOOMFIELD HILLS, MI, 48303, US

(21) Appl. No.: 12/826,101

(22) Filed: Jun. 29, 2010

Related U.S. Application Data
(60) Provisional application No. 61/213,726, filed on Jul. 7, 2009.

(51) Int. Cl. G09F 7/12; G09F 7/04

(52) U.S. Cl. 40/594

(57) ABSTRACT

A signage system having a signboard which is a flexible sheet of magnetically attractive material having a stick on adhesive over a mounting face thereof. The mounting face is opposite a display face, the adhesive is covered by a removable release sheet. The signage system further has a plurality of magnetic signage elements such as graphic elements and text boxes.

### FIELD OF THE INVENTION

This invention relates generally to signage systems and more particularly to changeable signage systems.

### BACKGROUND OF THE INVENTION

Conventional changeable signs typically utilize parallel oppositely opening channels for receiving and holding signage elements such as letters and numbers. Such signs are descriptively referred to as “line signs”.

Line signs are rather ineffective. Line signs lack the ability to utilize many of the graphic elements which a graphic artist would utilize in seeking to attract a consumer's attention and to “get the message across”. A line sign is more like a classified ad rather than a full page advertisement with colours and pictures and text in different fonts and sizes. Accordingly line signs are a relatively ineffective means of communicating with a potential consumer. As a result, the advertising landscape is littered with tens if not hundreds of thousands of abandoned or “ought to be abandoned” line signs.

FIG. 1a is a perspective view of an example of a common and rather ineffective line sign showing a changeable signboard 50 mounted between two posts 100 supporting fixed unchangeable signage 52 thereabove. Such fixed signs include mall signs displaying major tenants' signage and hotels or other businesses having a changeable sign mounted below the principal signage of the business for advertising special events and special packages. Although the intent behind such changeable signs is logical, the medium chosen, namely line signs, is typically not up to the task as being too lacklustre to attract the attention of consumers. Accordingly many such signs are either abandoned or underutilized.

Changeable signage in the form of line signs are generally rather cumbersome and include a significant amount of support structure. Accordingly erection of changeable signage in locations which are unsigned, have underutilized signage or have abandoned signage is cumbersome.

FIGS. 1b and 1c are respectively perspective and front elevational views illustrating a conventional portable changeable line sign 40. As with the signboard illustrated in FIG. 1a it is apparent that the message is limited by the use of letters and numerals of the same size with no ability for enhancement by way of pictures, text boxes or larger and smaller characters.

FIG. 1d is a front elevational view showing a conventional two post sign 50 with non-changeable signage 52 with an unused panel 54 in which there are no signage elements. Such a panel presents an opportunity for a changeable sign however, prior to the present invention there are no changeable signs which can take advantage of such available advertising space.

FIG. 1e is a perspective view of a building illustrating a variety of available signage opportunities including a window area 200, a smooth door area 202 and a smooth wall area 204. Traditionally fixed signage has been applied to such areas however there remains a need for easily installable vibrant “get the message across” changeable signage for simple installation on such surfaces.

FIG. 1f is an end elevation showing a gas bar having a canopy 210 surmounting gas pumps 212. Once again there remains a space 220 on the canopy/awning which presents a good opportunity for easily installable vibrant changeable signage. The prior lack of such signage systems leaves the space unutilized.

FIG. 1g is a perspective view showing part of a building having a smooth flat surface 240 on an awning which is devoid of any messages. Traditionally such space has been left empty or has been printed with non-changeable signage during manufacture of the awning. Such a space would be a prime candidate for an easily installable vibrant changeable sign system were such a system available.

FIG. 1h is a front elevation showing a front of a building, namely a movie theatre, having non-changeable signage 52 and line signs 60 to either side thereof. As with all line signs, the line signs 60 are rather bland and devoid of any captivating imagery which would enable much more effective communication.

It is an object of the present invention to provide a changeable signage system which is visually effective and which maybe conveniently mounted in simple fashion either over previous signage boards or on surfaces which previously had no signage mounted thereon.

### SUMMARY OF THE INVENTION

A signboard is provided which has a flexible sheet of magnetically attractive material having a stick on adhesive over a mounting face thereof. The mounting face is opposite a display face. The adhesive is covered by a release sheet. The release sheet is removeable.

A signage system according to an aspect of the present invention may include a magnetically attractive material as described above along with a plurality of magnetic signage elements including letters, numbers, punctuation marks, exclamation marks, figures, pictures and text boxes are provided for mounting on the flexible sheet of magnetically attracted material.

A method is provided for erecting a changeable sign comprising the steps of:
i) obtaining a sheet of flexible magnetically attracted material having a stick on adhesive face opposite a display face;
ii) adhering the sheet to an underlying surface with said stick on adhesive;
   and,
iii) placing magnetic signage elements on the display face.

The graphic elements may include letters, numbers, text boxes, punctuation pictures etc.

The underlying surface may be a face of a non-magnetically attractable changeable signboard.

### DESCRIPTION OF DRAWINGS

FIG. 1a is a front elevation illustrating a conventional two post sign with non-changeable and changeable signage portions;

FIG. 1b is a perspective view of a portable changeable “line sign”.

FIG. 1c is a front elevation corresponding to FIG. 1b;

FIG. 1d is a front elevation showing a conventional two post sign with non-changeable signage having an unused panel;

FIG. 1e is a perspective view of a building illustrating available signage opportunities;

FIG. 1f is an end elevation showing a gas bar having a canopy with available signage space;

FIG. 1g is a perspective view showing part of a building with available signage space on an awning;

FIG. 1h is a front elevation showing a front of a building having changeable and non-changeable signage space over an entrance;

FIG. 2a is a front elevation corresponding to FIG. 1a;

FIG. 2b is a view corresponding to FIG. 2a but showing in enlarged detail an end elevation illustrating securement of signage elements to the changeable signage portion;

FIG. 2c is a combination of a perspective view, an end elevation and a front elevation showing removal of changeable signage securement elements from the sign of FIG. 2b;

FIG. 2d is an end elevation of a signboard according to the present invention;

FIG. 2e is a perspective view corresponding to FIG. 2d;

FIG. 2f is a combination of perspective and front elevational views illustrating placement (mounting) of signboard according to the present invention over a panel of a two post sign after removal of signage securement elements as shown in FIG. 2c;

FIG. 2g is a front elevation illustrating the placement of removeable magnetic signage elements on the signboard of FIG. 2f;

FIG. 2h is a front elevation of a completed sign after placement of magnetic signage elements according to FIG. 2g;

FIG. 2i is an enlarged exploded perspective view showing in detail the elements of a signage system according to the present invention;

FIG. 2j is a pair of front elevational views showing a conventional two post sign before and after conversion of a changeable line sign portion to a changeable magnetic signage system according to the present invention;

FIG. 2k is a front elevational view showing mounting of a signage system according to one embodiment of the present invention over an unused portion of a non-changeable backlit signage panel of a conventional two post sign; and,

FIG. 2l is a front elevational view showing mounting of a protective device over a signage system according to the present invention.

FIG. 3a is a side elevation illustrating a signage system of the present invention applied to a trailer;

FIG. 3b is a perspective view illustrating a signage system according to the present invention applied to a side of a van;

FIG. 3c is a perspective view illustrating signage systems according to the present invention applied to a glass surface and a roof of a van;

FIG. 4a is a perspective view illustrating signage systems according to the present invention applied to indoor surfaces.

FIG. 5a is an end elevation of an alternate embodiment of a signboard according to the present invention;

FIG. 5b is a perspective view corresponding to FIG. 5a; and,

FIG. 5c is an enlarged exploded perspective view showing in detail the elements of the signage system according to the alternate embodiment of the present invention.

### DESCRIPTION OF PREFERRED EMBODIMENTS

A signage system according to the present invention is generally indicated by reference 10 in the accompanying illustrations. The signage system has a signboard 20 which is a flexible magnetically attractive sheet 21 coated on a mounting face 22 with a stick-on adhesive 30. The stick-on adhesive 30 is covered by a removeable release sheet 32 pending deployment when the release sheet 32 is removed to expose the adhesive.

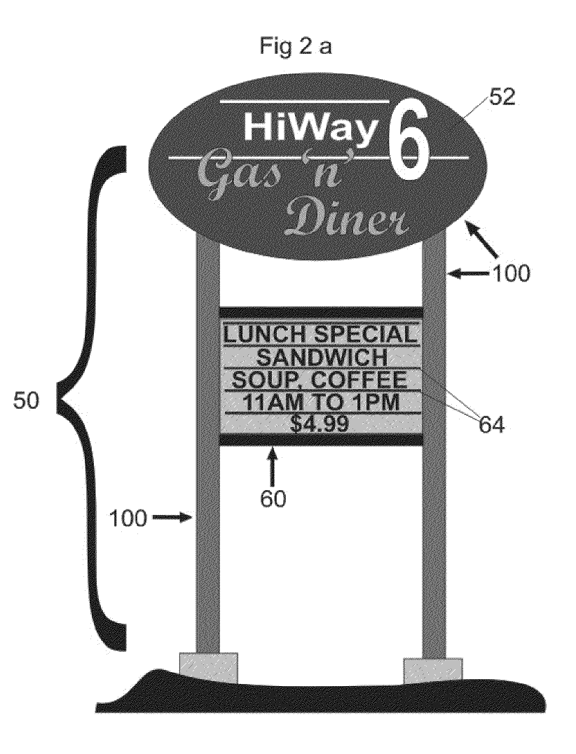

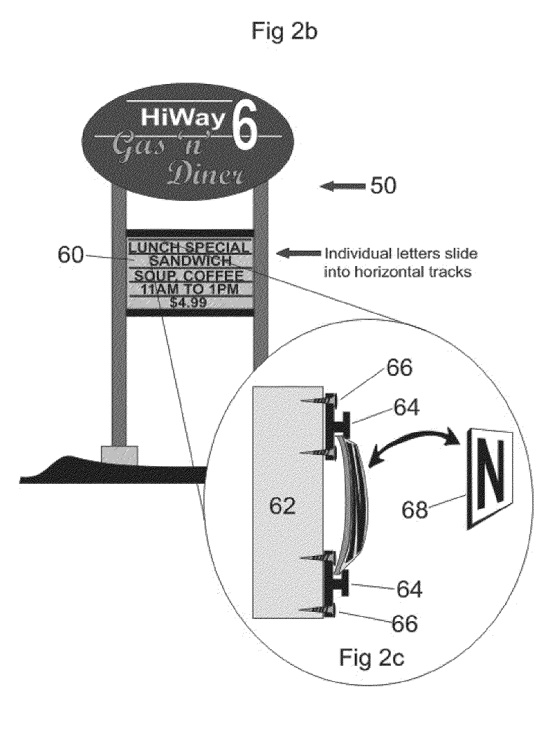

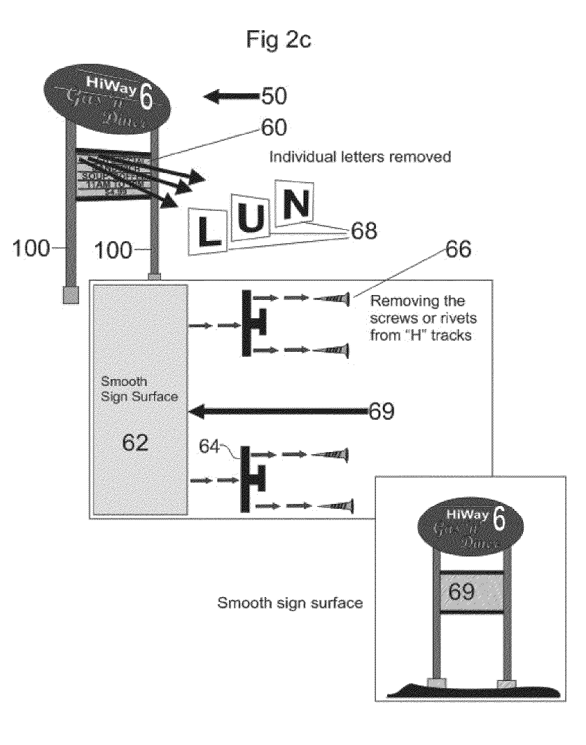

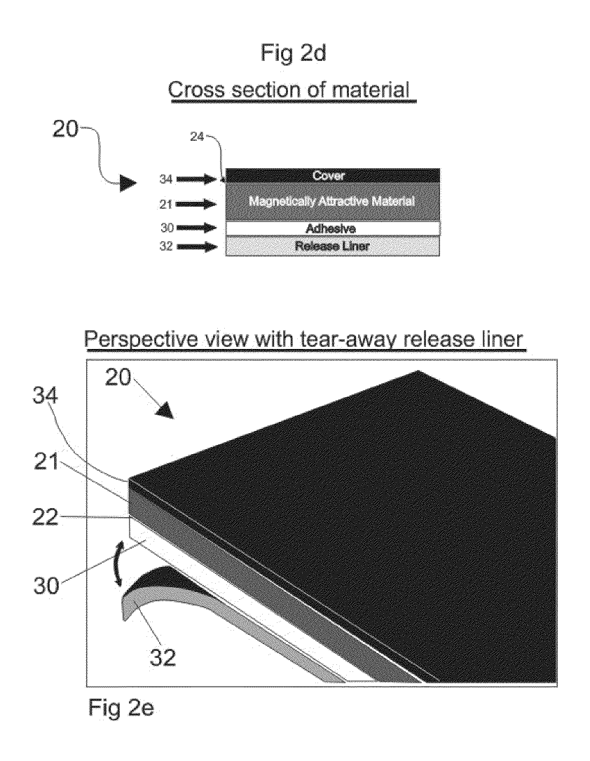

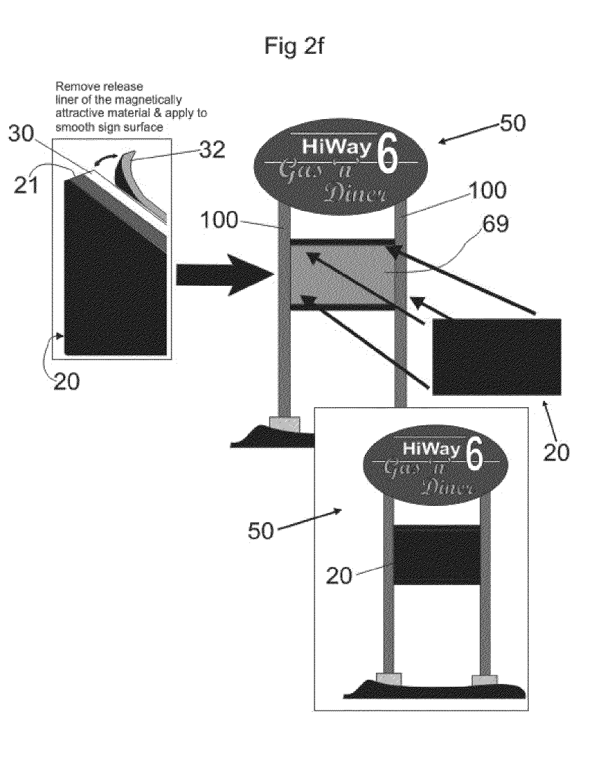

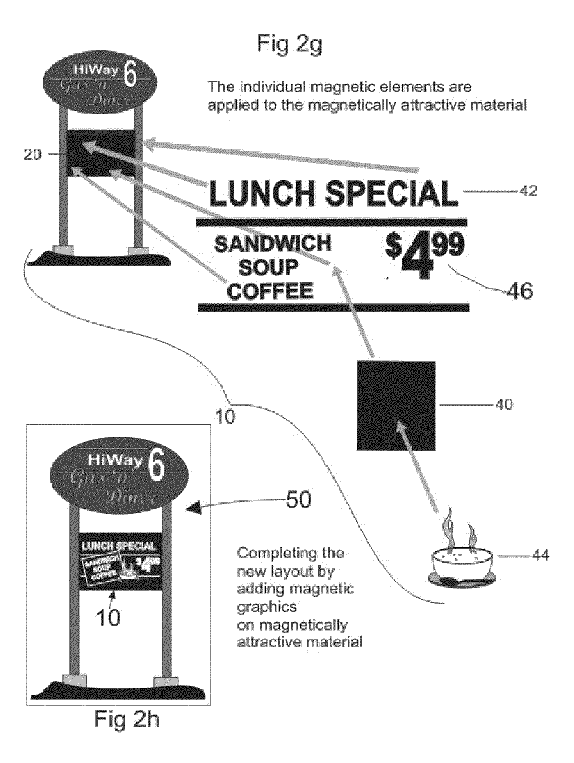

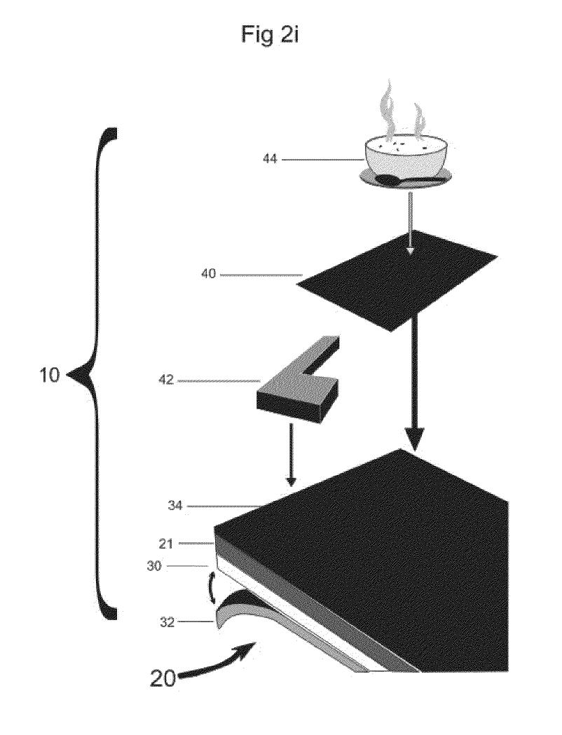

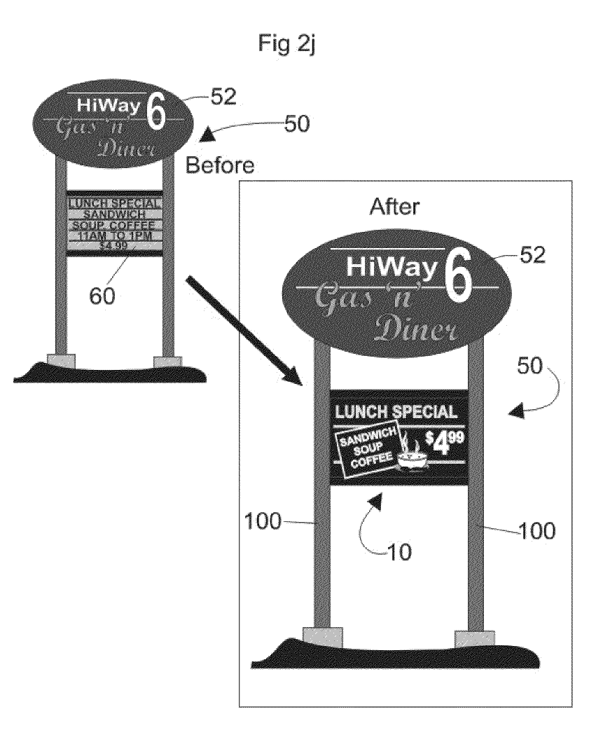

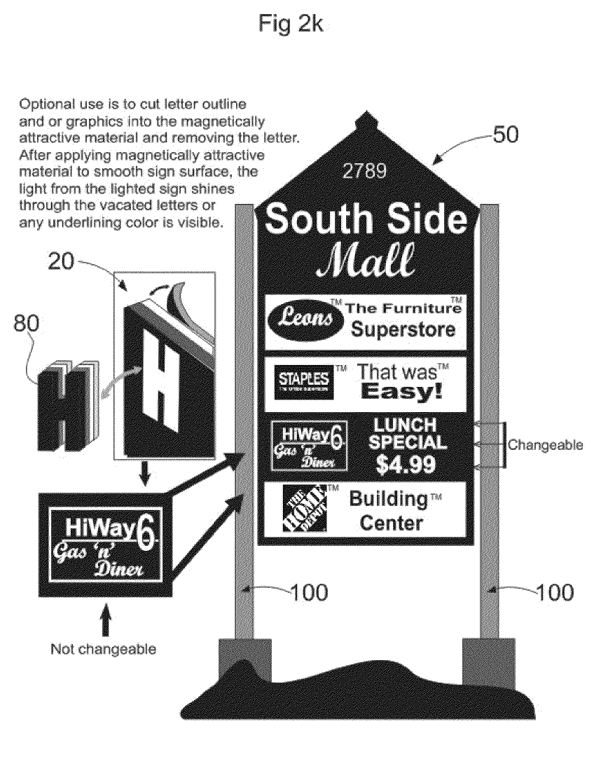

As shown in FIG. 2i, magnetic signage elements such as a text box 40, letter 42 and picture 44 are provided which can be held to the signboard 20 by magnetic attraction. The foregoing signage elements are exemplary and other elements may be used as will be appreciated by persons skilled in the art. Examples of further signage elements include numbers, punctuation and exclamation marks, leader lines, arrows etc.

The magnetic signage elements may be placed directly on a display face 24 of the signboard. Alternatively the display face 24 may in turn be covered with a decorative coating such as a sheet of coloured vinyl 34.

FIG. 2a illustrates a typical sign 50 having a conventional line sign 60 mounted therebelow. FIG. 2b illustrates in detail the construction of the typical line sign. The line sign 60 has a signboard 62 to which are attached horizontal tracks or channel members 64 (FIG. 2c) using suitable fasteners such as screws 66. Signage elements such as letters 68 are slid into the spaces between the tracks or channel members 64.

A first step in converting a line sign to a sign according to the present invention is to remove the screws 66 (or other fastening systems such as rivets or adhesives) in order to enable a movement of the channels or tracks 64 or to leave a smooth sign surface 69. FIG. 2c illustrates such removal.

FIG. 2f illustrates the sequence of steps in applying a magnetically attractive signboard 20 according to the present invention to the smooth surface 69 initially illustrated in FIG. 2c. The release sheet 32 is removed to expose the adhesive material 30. The signboard 20 with the release sheet removed is adhesively mounted to the smooth surface 69.

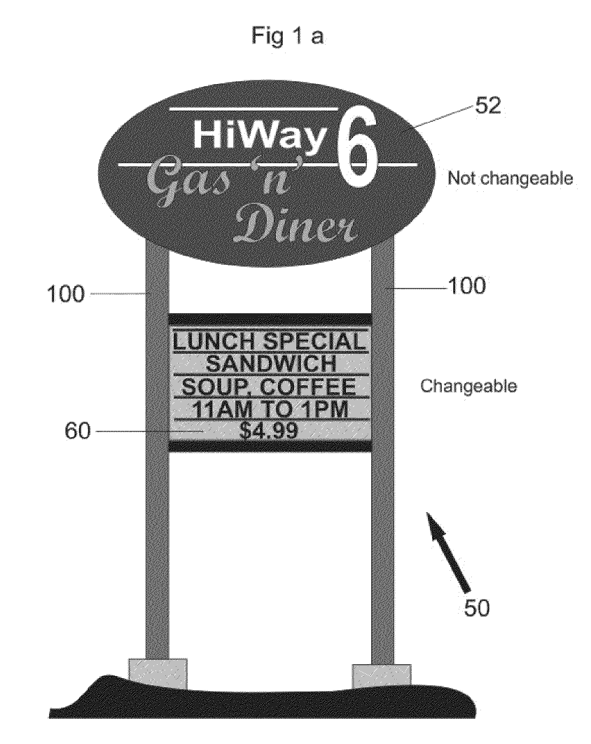

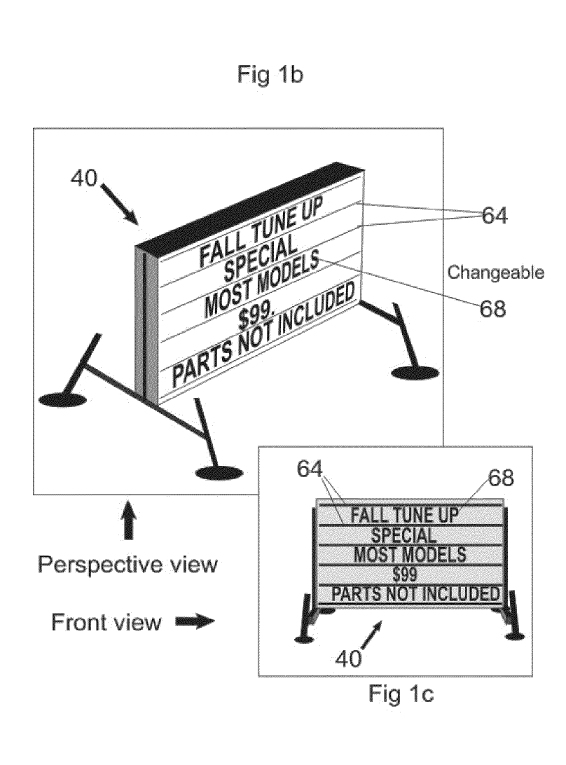

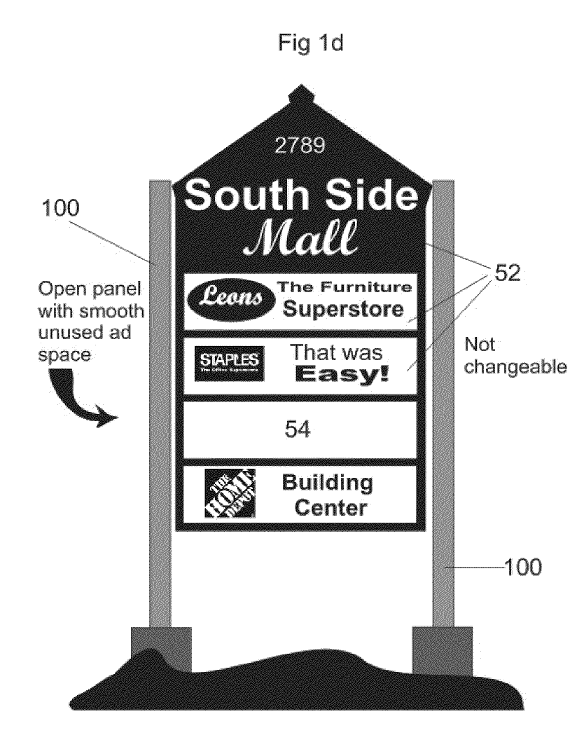

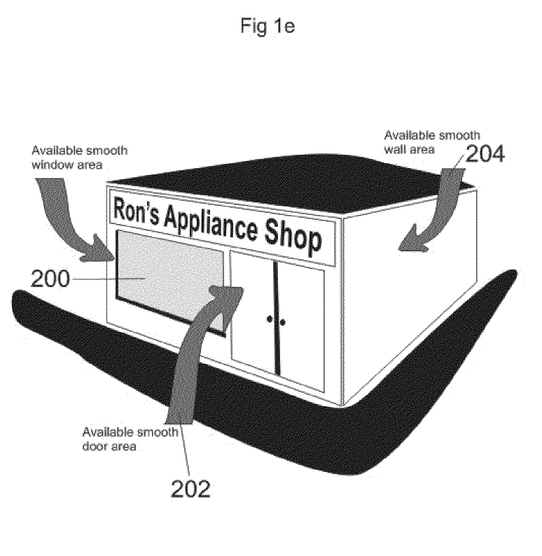

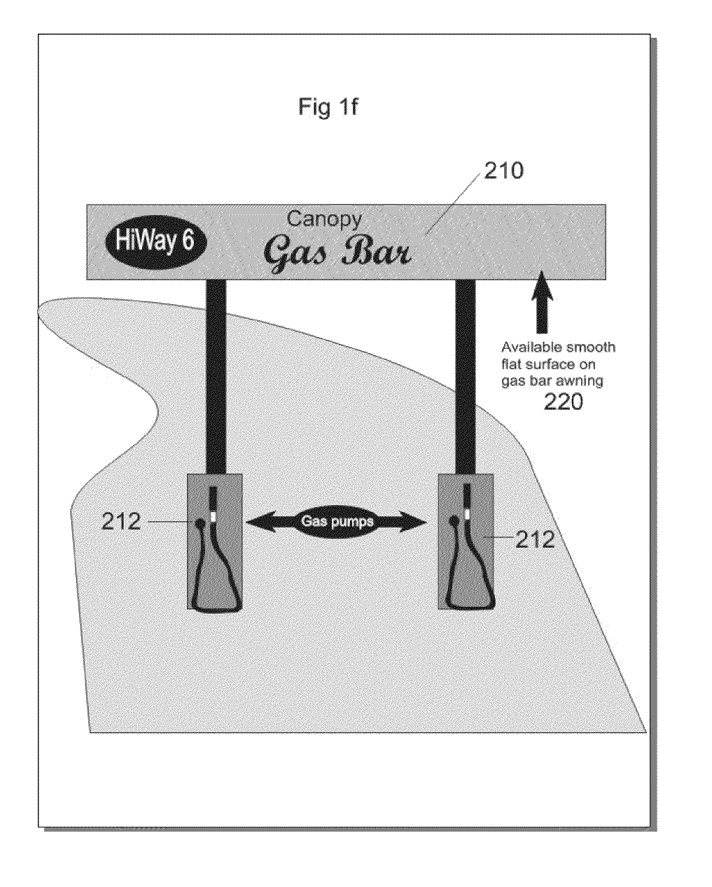

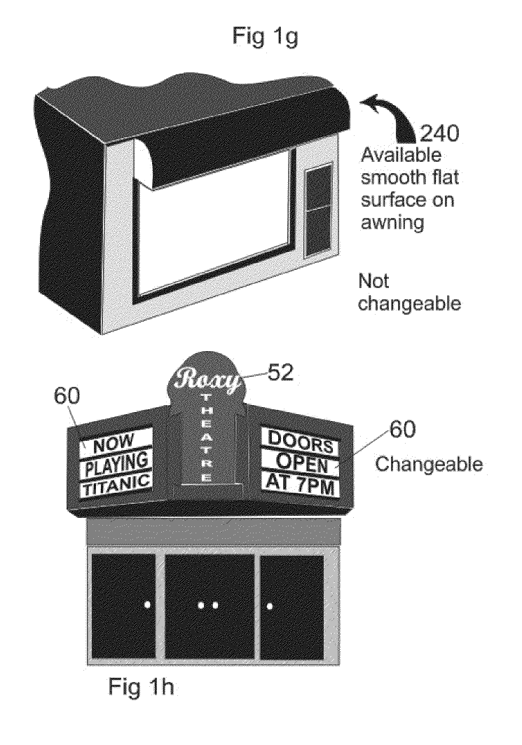

It will be appreciated that although a two post sign 50 is illustrated, the smooth surface needn't be the result of removing channels or tracks 64 from a line sign 60. For example the smooth surface could be the surface 54 in FIG. 1d, any of the surfaces 200, 202 and 204 in FIG. 1e, the surface 220 in the canopy of the gas bar illustrated in FIG. 1f or the awning illustrated in FIG. 1g. The foregoing are exemplary and other smooth surface opportunities may well present themselves in practice, for example other exterior and interior surfaces and buildings.

FIG. 2g illustrates the completion of the sign by mounting signage elements such a text box 40, a picture 44 (of a soup bowl), letters 42 and numbers 46 to the signboard 20. FIG. 2h illustrates a completed sign. The placement of signage elements is illustrated in more detail in the exploded view of FIG. 2i. The signage elements have a flexible magnetic backing and may be of one or more layers of decoratively coloured vinyl sheeting surmounting the magnetic background.

Although for cost reasons it is expected that the signboard would be magnetically attractive and the signage elements magnetic, it is conceivable that this could be reversed and accordingly the expressions “magnetic” and “magnetically attractive” in the claims should be interpreted as being interchangeable as long as one of the signboard and signage elements is magnetically attractive and the other of the signboard and signage elements is magnetic.

FIG. 2j shows before and after illustrations in the conversion of a line sign to a signage system according to the present invention. The effectiveness of communication with the signage system of the present invention is significantly greater than with line signs because it enables the use of communication tools other than words. In the line sign all of the signage elements are of the same size and reading lines of text is required in order to discern the message. The message is not visually captivating and could easily be missed particularly if one has a short period of time to glance at the sign in passing.

In contrast the signage system according to the present invention immediately jumps out as offering soup (the picture 44) for $4.99. The picture immediately captures one's eye and the price is the largest signage element on the sign. Having immediately identified that soup is being offered for $4.99 one can then see that this is a lunch special and that the special also includes a sandwich and coffee. In other words, the information comes out at different rates depending on whether the image is pictorial and the size of the signage elements. Accordingly graphic tools control the sequence rather than the order of the words. The signage elements furthermore are very easy to erect because the expression “SANDWICH SOUP COFFEE” is mounted on a text box which could be done prior to mounting the text box on the magnetically attractive signboard 20.

In some instances it may be desirable to prevent tampering with the signage elements, for example where the signboard 20 is low enough to be readily accessible by someone standing under the sign. In such circumstances a protective device such as the screen 70 illustrated in FIG. 2l may be securable over the completed sign. Securement may be by hinging, hooking, screwing or any suitable means which enables simple removal of the protective device for sign changes. The protective device may be a screen 70 as illustrated of metal or non-metal, a plexi glass sheet or any other suitable covering which enables the signboard 20 to be viewed in a relatively unobstructed manner therethrough.

FIG. 2k illustrates an optional configuration for the signboard 20. According to the FIG. 2k embodiment, elements such as the letter 80 would be cut from the signboard 20 to leave in effect a window through which the underlying surface is visible. Removal of such elements makes that portion of the signboard non-changeable with the remaining portion being a changeable signboard. Such an arrangement might be desirable for example where the underlying surface is backlit as the light from the backlit surface would be visible through the non-changeable portion of the signboard.

The above illustrations include trademarks which belong to their respective owners and appropriate notice to this effect has been included in the drawings. The applicant is not affiliated with any of the trademark owners and no endorsement is to be suggested or implied.

As can be seen from the illustrations, the signage system 10 of the present invention is capable of significantly enhanced graphic artistry than possible with conventional line signs. Accordingly the signage system of the present invention enables resurrection of abandoned and underutilized line signs by conversion to visually captivating changeable signs capable of effective communication.

An exemplary sheet of magnetically attractive material for use in a signboard 20 according to the present invention is sold under the trademark RubberSteel by MagnumMagnetics of Marietta, Ohio. The adhesive 3 and may be any suitable dry or wet adhesive. Generally the adhesive 30 should provide secure attachment to the underlying surface while allowing for removal without damage to the underlying surface (unless removal isn't a concern). The adhesive may be coated on the signboard 20 and then covered with the release sheet 32. Alternatively, the adhesive may be coated on the release sheet 32 and then applied with the release sheet 32 to the signboard 20. Other variants may be apparent to persons skilled in the relevant art.

The magnetically attractive material may come in sheets or rolls. Accordingly reference to “sheets” is not intended to exclude roll material but instead to refer to portions cut from roll material.

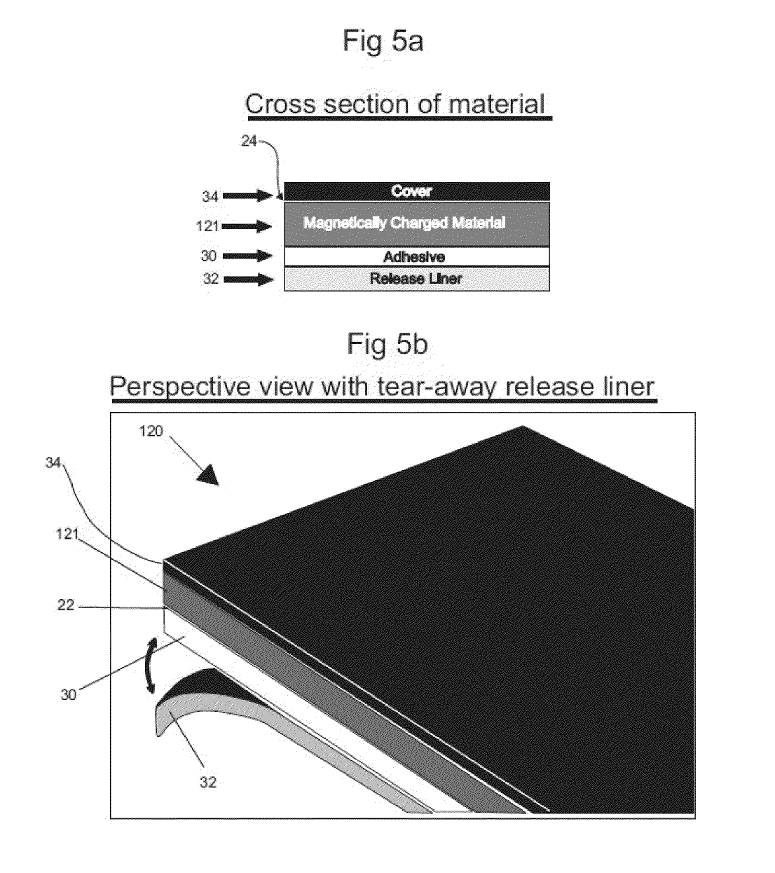

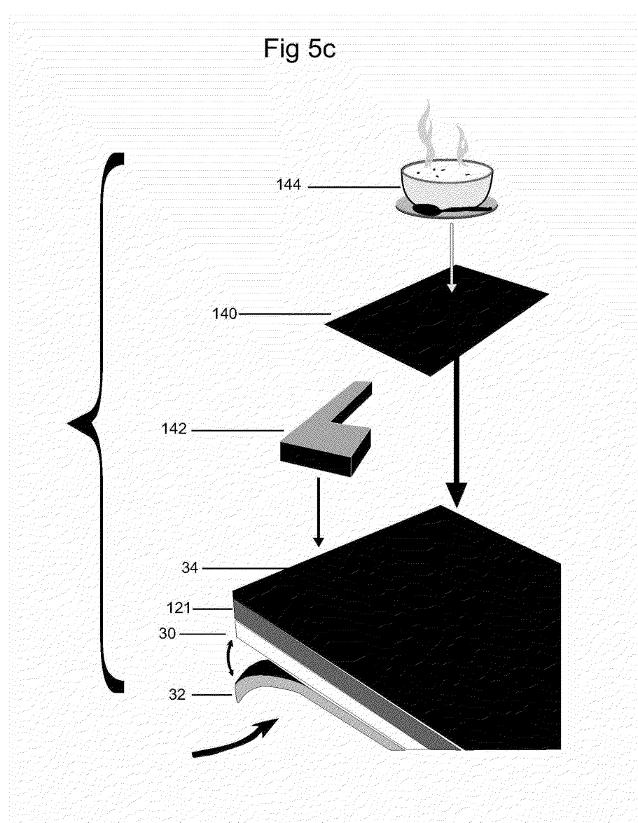

In the above description the signboard is largely described as being a sheet of flexible magnetically attractive material with magnetic signage elements being placed thereon. As mentioned above, it will be appreciated by persons skilled in the art that the arrangement may be reversed whereby a signboard 120 may be of a magnetic or magnetically charged material 121 with signage elements 140, 142 being made of a magnetically attractive material. The expression “magnetically charged” is intended to refer to a material that has magnetic properties in that it attracts magnetically attractive material. Such an arrangement is illustrated in FIGS. 5a, 5b and 5c.

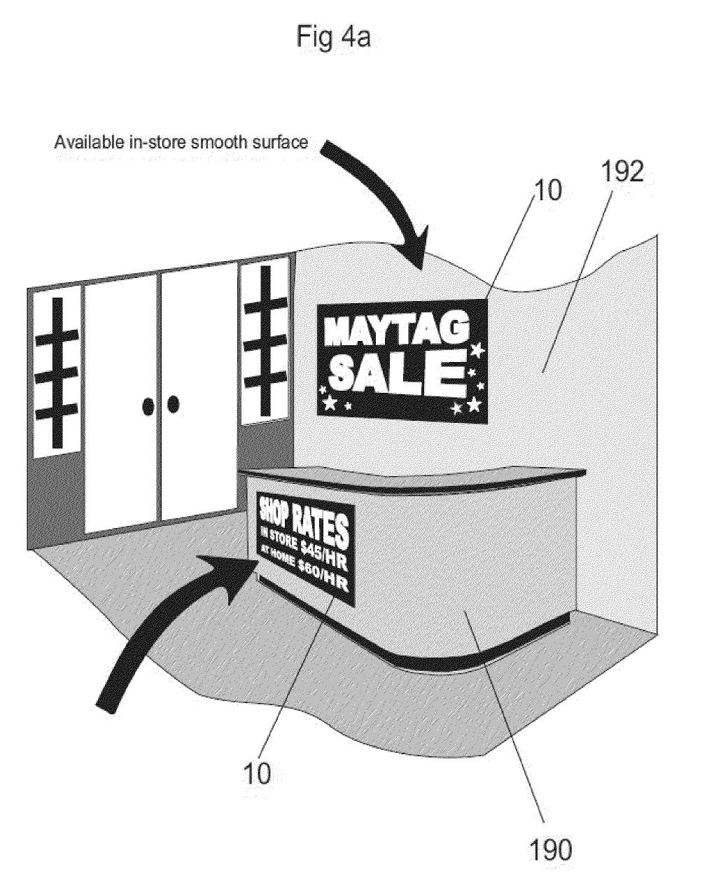

The signage does not have to be applied outdoors. It may also be used for indoor applications as illustrated in FIG. 4a which shows the signage system 10 applied to a counter 190 and a wall 192.

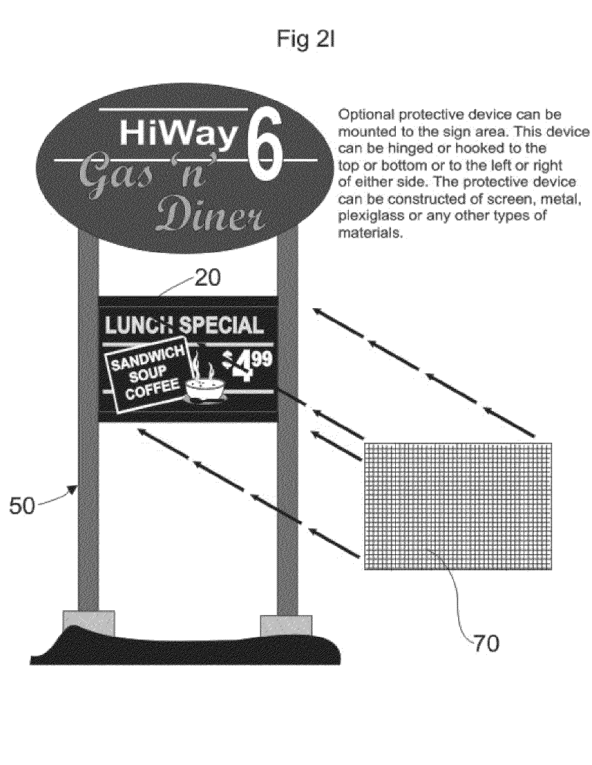

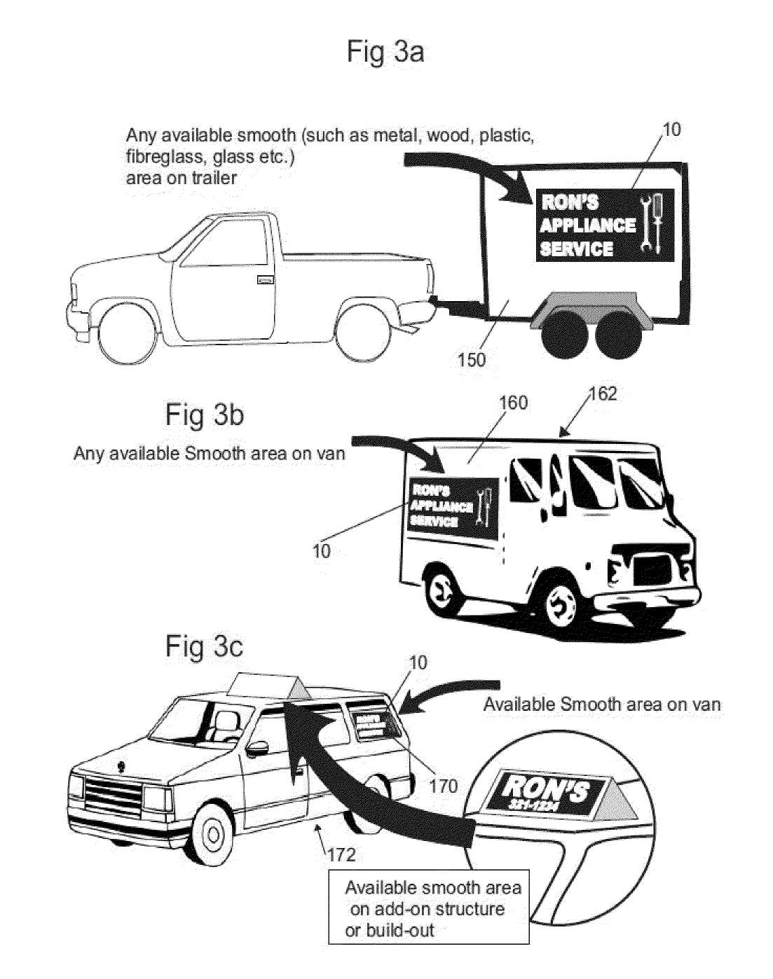

The signage system 10 of the present invention is not restricted to static applications and may be adapted to vehicular applications, particularly in situations where magnetic signs would ordinarily not adhere. Examples include surfaces such as glass, aluminum, fibreglass and plastic panels which ordinarily would not be magnetically attractive. Such applications are illustrated in FIGS. 3a, 3b and 3c which respectively show a signage system 10 applied to a trailer 150, a side 160 of a van 162 and a window 170 of a van 172.

As an alternative to applying the magnetically attractive material 21 directly to a surface such as an existing sign or the side of a building, the magnetically attractive material 21 may be applied to a panel or board. The panel or board can then be attached to the sign or other surface. In some instances this may be preferable to adhering the magnetically attractive material 21 directly to an underlying surface as it might be easier to remove the panel or board to restore the original surface than peeling away the magnetically attractive material 21.

The above description is intended in an illustrative rather than a restrictive sense. One or more currently preferred embodiments have been described by way of example. It will be apparent to persons skilled in the art that a number of variations and modifications can be made without departing from the scope of the invention as defined in the claims set out below.

1. A method of erecting a changeable sign comprising the steps of:
i) obtaining a sheet of flexible material which is one of magnetically attractive and magnetically charged having stick-on adhesive face opposite a display face;
ii) adhering said sheet to an underlying surface; and,
iii) placing signage elements on said display face elements are other of magnetically attractive and magnetically charged.

2. The method of claim 1 wherein said adhesive face is covered by a release sheet and step (ii) includes removing said release sheet from said adhesive face.

3. The method of claim 2 wherein said magnetic elements include one or more graphic elements selected from the group comprising, pictures, letters, numbers, text boxes, punctuation and exclamation marks.

4. The method of claim 3 wherein said underlying surface is a face of a non-magnetically attractive changeable signboard.

5. An adhesively mountable magnetic signage system comprising:
a flexible sheet which is one of a magnetically attractive or magnetically charged material having a stick-on adhesive over a mounting face thereof, said mounting face being opposite a display face, said adhesive being covered by a release sheet;
a plurality of signage elements which are the other of magnetically attractive and magnetically charged selected from letters, numbers, punctuation marks, figures, pictures and text boxes for mounting on said sheet.

6. A signboard comprising:
a sheet of a flexible magnetically attractive or magnetically charged material having a stick-on adhesive over a mounting face thereof, said mounting face being opposite a display face; said adhesive being covered by a release sheet.

7. The signboard of claim 6 wherein said display face is coated with a magnetically permeable decorative coating.
